(19) United States
(12) Patent Application Publication
(10) Pub. No.: US 2025/0308010 A1
(43) Pub. Date: Oct. 2, 2025

(54) BINARISED IMAGE GENERATION METHOD, DEFECT INSPECTION METHOD AND PROGRAM

(71) Applicant: MITUTOYO CORPORATION, Kawasaki (JP)

(72) Inventor: Akira Kashiwagi, Kanagawa (JP)

(21) Appl. No.: 19/084,618

(22) Filed: Mar. 19, 2025

(30) Foreign Application Priority Data
Mar. 27, 2024 (JP) 2024-052566

(51) Int. Cl. G06T 7/00; G06T 5/70

(52) U.S. Cl. CPC G06T 7/0002; G06T 5/70

(57) ABSTRACT

A binarized image generation method that generates a binarized image of a target object, wherein for each pixel in an image of the target object: a reference value calculation step calculates a reference value based on the brightness values of the pixels around the subject pixel; a defect candidate region extraction threshold calculation step calculates a defect candidate region extraction threshold by multiplying a certain constant by the reference value; an over-detection reduction threshold setting step sets a threshold; and a threshold comparison step determines whether the brightness value of the subject pixel is above both the defect candidate region extraction threshold and the over-detection reduction threshold, and then generates a binarized image of the target object, where the image is binarized into two regions: one region consisting of pixels whose brightness values are greater than or equal to both thresholds, and the other region.

### CROSS-REFERENCE TO RELATED APPLICATION

This non-provisional application claims priority under 35 U.S.C. § 119(a) from Japanese Patent Application No. 2024-052566, filed on Mar. 27, 2024, the entire contents of which are incorporated herein by reference.

### BACKGROUND OF THE INVENTION

### Field of the Invention

The present invention relates to a binarized image generation method, a defect inspection method, and a program for the inspection of defects on the surface of an object based on an image obtained by capturing the object.

### Description of the Related Art

The image measuring apparatus captures an image of the measurement object, analyzes the image, extracts the point cloud of the edges within the image, and evaluates the distance, inclination, diameter, width, etc. of the geometric shapes approximated from the extracted edge point cloud, such as lines, circles, and polygons. In addition to evaluating geometric shapes, the recent image measuring apparatus is also implemented with algorithms that detect defects such as contamination on the workpiece, foreign objects inside hole shapes, minute chips of the workpiece, deformation, burrs, and contamination, and defect inspection based on the image is realized (see, for example, JP2020-071106).

When performing defect inspection based on the image, for example, by setting a threshold for brightness value and binarizing the image based on the fact that the brightness value of the defective area is higher than that of the normal area, the pixel region exceeding the threshold can be extracted as the defective area. Binarization can be performed using various methods. For example, the local thresholding described in a non-patent document (P.K.Sahoo, S.Soltani, A.K.C. Wong and Y.C.Chen, “A Survey of Thresholding Techniques”, Computer Vision, Graphics, and Image Processing, Vol.41, Issue2, 1988, pp. 233-260) is a method of determining a threshold for binarizing each pixel by considering the brightness values of surrounding pixels and applying the threshold value to the subject pixel, in order to determine whether each pixel is 1 or 0. Local thresholding is an effective method for setting the threshold for each pixel appropriately when the brightness of the entire image is not uniform.

### SUMMARY OF THE INVENTION

### Problems to be Solved by the Invention

The image may include noise due to uneven intensity of lighting or the characteristics of the image sensor. If the noise is present, even if the actual brightness of the pixel does not exceed the threshold, the noise may cause the pixel to exceed the threshold and appear in the binarized image together with the defective area, resulting in over-detection and the risk of incorrectly judging the defect. Such over-detection is particularly likely to occur in regions where the pixel brightness is low.

An object of the present invention is to provide a binarized image generation method, a defect inspection method, and a program that can suppress the over-detection due to noise in the extraction of defect candidate regions.

### Means for Solving the Problems

A binarized image generation method according to one aspect of the present invention generates a binarized image of a target object. The binarized image generation method performs for each pixel in an image of the target object: a reference value calculation step that calculates a reference value indicating the brightness of the area around the subject pixel based on the brightness values of the pixels around the subject pixel; a defect candidate region extraction threshold calculation step that calculates a defect candidate region extraction threshold for extracting defect candidate regions by multiplying a certain constant based on the characteristics of the target defect by the reference value; an over-detection reduction threshold setting step that sets an over-detection reduction threshold for reducing the effect of noise; and a threshold comparison step that determines whether the brightness value of the subject pixel is above both the defect candidate region extraction threshold and the over-detection reduction threshold, and then performs a binarized image generation step that generates a binarized image of the target object, where the image is binarized into two regions: one region consisting of pixels whose brightness values are greater than or equal to both thresholds, and the other region.

### Effects of the Invention

In the binarized image generation method of the present invention, in addition to using the defect candidate region extraction threshold obtained by multiplying the reference value indicating the brightness of the pixels around the subject pixel by a constant as the binarization threshold of the image, in order to reduce the over-detection of defect candidate regions due to noise, the defect candidate region is extracted using the over-detection reduction threshold as the binarization threshold in low-brightness regions. Accordingly, it is possible to generate a binarized image that suppresses the over-detection of noise when extracting defect candidate regions, and by using such a binarized image, it is also possible to suppress erroneous judgments in defect inspection based on the binarized image.

### BRIEF DESCRIPTION OF THE DRAWINGS

FIG. 1 is a perspective view showing an example of the configuration of the image measuring apparatus 1.

FIG. 2 is a schematic diagram showing a configuration of the imaging capturing unit 120 along with the stage 100.

FIG. 3 is a block diagram showing a configuration of the position acquiring unit 110.

FIG. 4 is a block diagram showing a configuration of a computer main body 141.

FIG. 5 shows an example of a view of the screen display.

FIG. 6 shows the processing flow of the defect inspection method.

FIG. 7 shows an example of the relationship between the binarization threshold and the reference value.

FIG. 8 shows an example of the relationship between the binarization threshold, the reference value, and the defect candidate region extraction threshold.

FIG. 9 shows another example of the relationship between the binarization threshold, the reference value, and the defect candidate region extraction threshold.

FIG. 10 shows another example of the relationship between the binarization threshold, the reference value, the defect candidate region extraction threshold, and the over-detection reduction threshold.

### DETAILED DESCRIPTION OF THE EMBODIMENTS

Embodiments of the present invention will be described below with reference to the drawings. In the following description, portions already described are denoted by the same reference numerals, and the description thereof is omitted.

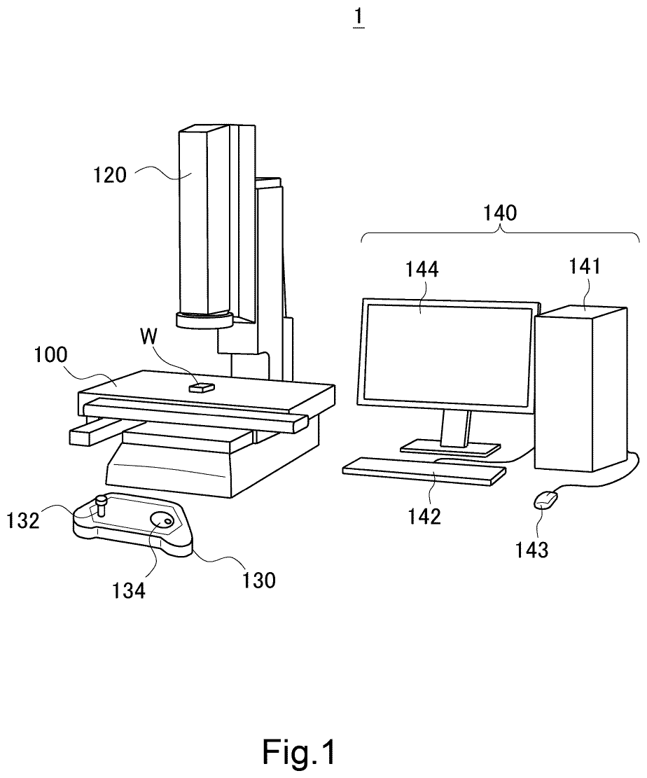

FIG. 1 is a perspective view showing an example of the configuration of the image measuring apparatus 1. The image measuring apparatus includes a stage 100, a position acquiring unit 110, an imaging capturing unit 120, a remote box 130, and a computer system 140.

The stage 100 is arranged so that its upper surface is horizontal, and a measurement target object W is placed on the upper surface. At least the part of the top surface of the stage 100 where the measurement target object W is placed is formed of a material that transmits light, such as glass. The stage 100 is driven by an X-axis drive motor and a Y-axis drive motor, which are not shown in the drawings, and can move in the X-axis direction and Y-axis direction parallel to the horizontal plane. The drive control signals for the drive motors of each axis are provided from the remote box 130 and computer system 140 described later to the drive motors of each axis.

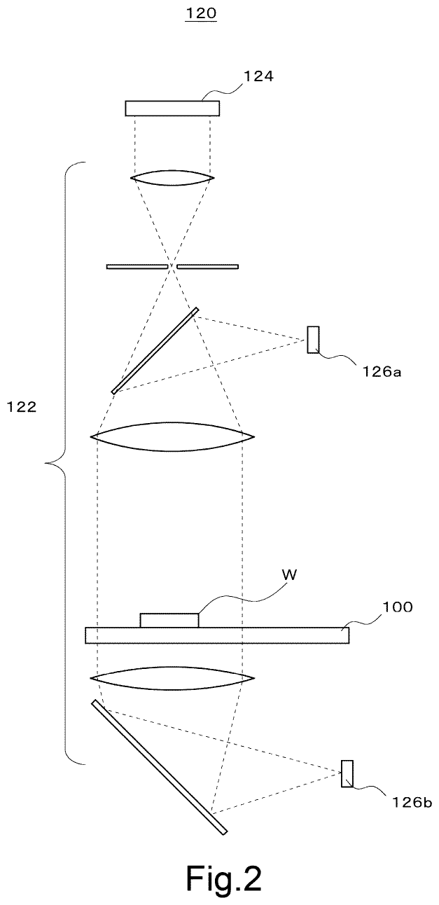

FIG. 2 is a schematic diagram showing a configuration of the imaging capturing unit 120 along with the stage 100. The image capturing unit 120 includes an optical system 122, an image sensor 124, and a light source 126. The optical system 122, for example, consists of a telecentric optical system that combines a plurality of lenses and an aperture. In the telecentric optical system, the main rays can be considered to be parallel light, so the dimensions in the captured image do not depend on the position in the Z-axis direction (height direction). For this reason, the telecentric optical system is suitable for measuring the measurement target object W with undulations (e.g., steps or holes). The light source 126 irradiates light on at least the part of the measurement target object W to be imaged under the control of the computer system 140 when the image of the measurement target object W is captured. In this embodiment, there is a light source 126a for epi-illumination that irradiates light from above (i.e., from the image sensor 124 side) towards the measurement target object W via the optical system 122, and a light source 126b for transillumination that irradiates light from below (i.e., from the back side of the stage 100) towards the measurement target object W. The image sensor 124 is a two-dimensional image sensor such as a CCD or CMOS. The image of the measurement target object W is formed on the light-receiving surface of the image sensor 124 by the optical system 122. The image sensor 124 captures the formed image and outputs image data in a predetermined format. This image data contains information on the pixels that constitute the image, as well as an index that indicates the order of image capture. The image capturing unit 120 transmits the image signals output by the image sensor 124 to the computer system 140. The computer system 140 and the image capturing unit 120 are connected using a general-purpose communication standard such as USB (Universal Serial Bus). In addition, the image capturing unit 120 outputs a trigger signal to the latch unit 118 at the timing of completing the capturing of one image (one frame).

The image capturing unit 120 is driven by a Z-axis drive motor that is not shown in the drawings, and is capable of moving in the Z-axis direction (i.e., a direction perpendicular to the top surface of the stage 100). Focus adjustment is performed by adjusting the Z-axis position of the image capturing unit 120. The drive control signal for the Z-axis drive motor is provided from the remote box 130 and computer system 140 described later.

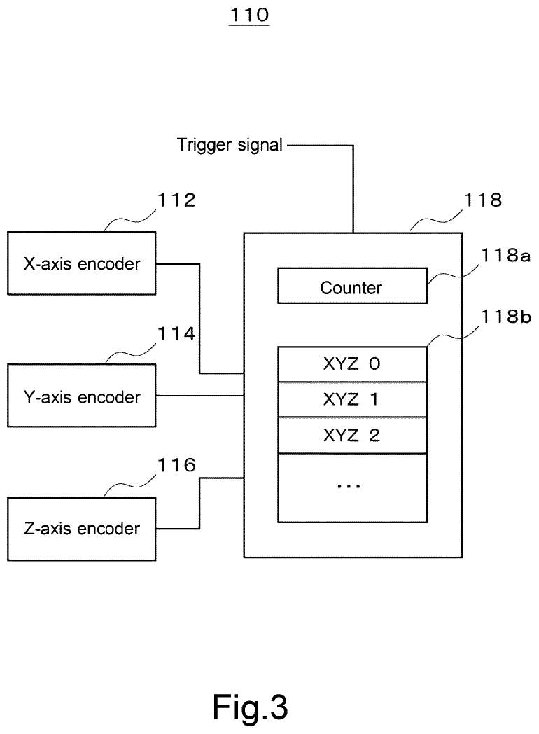

FIG. 3 is a block diagram showing a configuration of the position acquiring unit 110. The position acquiring unit 110 has an X-axis encoder 112, a Y-axis encoder 114, a Z-axis encoder 116, and the latch unit 118.

The X-axis encoder 112 measures and outputs the position coordinate in the X-axis direction of the stage 100. The Y-axis encoder 114 measures and outputs the position coordinate in the Y-axis direction of the stage 100. The Z-axis encoder 116 measures and outputs the position coordinate in the Z-axis direction of the image capturing unit 120. Each encoder is equipped with a graduated scale and a scale reader that reads the scale. The scale can be attached to the movable parts of the stage 100 and image capturing unit 120 along each axis. On the other hand, the scale readers are placed on the non-movable parts.

The latch unit 118 includes a counter 118a and a buffer 118b. The counter 118a increases the count value by 1 when an external trigger signal (e.g., pulse signal) is supplied. The value of counter 118a is reset as appropriate based on the instructions of computer system 140. The buffer 118b has a storage area for a plurality of addresses, and at the timing when the trigger signal is supplied, the output value of the encoder of each axis is latched and stored in the storage area of the address corresponding to the count value of the counter 118a. The trigger signal can be supplied, for example, from the image sensor 124 at the timing when the capture of one image is completed. The position coordinates of each axis held by the latch unit 118 are associated with address values (i.e., count values) and are taken into the computer system 140 as appropriate. The computer system 140 and the latch unit 118 are connected using a general-purpose communication standard such as USB (Universal Serial Bus). The image data and position coordinates are imported into the computer system 140 separately, but the image data is indexed to indicate the order in which they were captured, and the position coordinates are associated with a count value to indicate the order in which they were captured, so that even if they were imported into the computer system 140 asynchronously, they can be associated after being imported.

Returning to FIG. 1, the remote box 130 is an operating means for setting the position of the stage 100 and the image capturing unit 120, and transmits drive control signals to the X-axis drive motor, Y-axis drive motor, and Z-axis drive motor via wired or wireless communication in response to operation by the operator. The remote box 130 includes a joystick 132 and a jog shuttle 134. The joystick 132 is an input device for setting the position of the stage 100, and the remote box 130 sends drive control signals to move the stage 100 in the X-axis and Y-axis directions according to the tilt direction of the joystick 132. The jog shuttle 134 is an input device for setting the Z-axis direction position of the image capturing unit 120, and the remote box 130 transmits drive control signals to move the image capturing unit 120 in the Z-axis direction according to the rotation direction, rotation amount, and rotation speed of the jog shuttle 134.

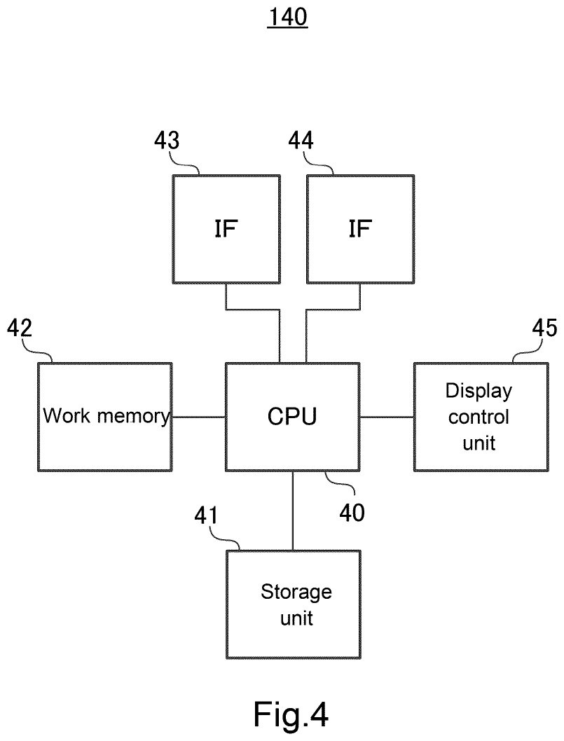

The computer system 140 includes a computer body 141, a keyboard 142, a mouse 143, and a display 144. FIG. 4 is a block diagram showing a configuration of a computer main body 141. The computer body 141 includes a CPU 40 that serves as the center of control, a storage unit 41, a work memory 42, interfaces 43 and 44 (shown as “IF” in FIG. 4), and a display control unit 45 that controls the view on the display 144.

Operator instruction information input from the keyboard 142 or the mouse 143 is input to the CPU 40 via the interface 43. The interface 44 is connected to the image capturing unit 120 and the stage 100, supplies various control signals from the CPU 40 to the image capturing unit 120 and the stage 100, receives various status information and measurement results from the image capturing unit 120 and the stage 100, and inputs them to the CPU 40.

The display control unit 45 causes the image captured by the image capturing unit 120 to be displayed on the display 144. In addition, the display control unit 45 causes the display 144 to show the images captured by the image capturing unit 120, as well as the interface for inputting control instructions to the image measuring apparatus 1 and the interface for the tool for analyzing the captured images.

The work memory 42 provides a work area for various types of processing of the CPU 40. The storage unit 41 is configured by, for example, a hard disk drive, a RAM, and the like, and stores programs to be executed by the CPU 40, the image data captured by the image capturing unit 120, and other data.

Based on various types of information input via the respective interfaces, the operator instructions, the measurement definition program (part program) stored in the storage unit 41, and the like, the CPU 40 performs various types of processing including: control of the image capturing unit 120, X-axis drive motor, Y-axis drive motor, and Z-axis drive motor, etc., setting of the moving path of the image capturing unit 120 and adjustment of the moving speed and exposure time, adjustment of the light intensity of the light source 126, image capturing of two-dimensional images by the image capturing unit 120, image stitching processing that pastes together a plurality of partial images, and analysis of the overall image obtained by image capturing, etc.

Hereafter, the measurement performed by using the image measuring apparatus 1 is explained.

### Basic Image Measurement

First, the operator moves the stage 100 so that the measurement target object W enters the imaging field of view by operation of the joystick 132 or by control of the computer system 140. Then, the Z-axis position of the image capturing unit 120 is adjusted so that the measurement target object W is in focus. After the measurement target object W is in focus, an image for measurement is captured using the image sensor 124. At this time, the coordinates of stage 100 output by the X-axis encoder 112 and Y-axis encoder 114 are captured by the computer system 140 along with the captured image, and stored in the storage unit 41. Specifically, a pulse is output as a trigger signal to the latch unit 118 at the timing when the image capturing unit 124 completes capturing one image. The latch unit 118 latches and holds the position coordinates of each axis at the timing of the rising transition of the pulse (i.e., almost simultaneously with the completion of image capturing). The computer system 140 acquires image signals from the image capturing unit 124 and acquires the position coordinates when the image was captured from the latch unit 118, and stores them in association with each other.

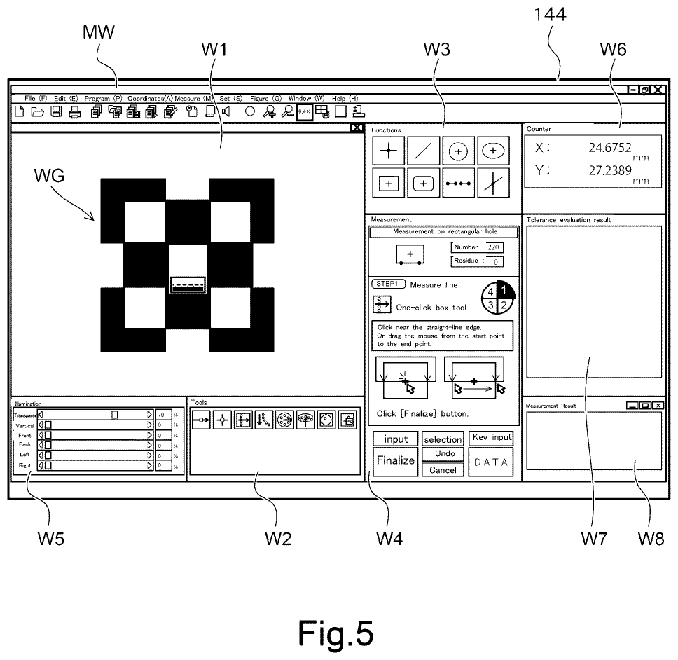

The computer system 140 displays the obtained images for measurement on the display 144, together with the interface of the measurement tool for analyzing the image. FIG. 5 shows an example of a view of the screen display. This screen display is shown on the display 144 by a program (measurement application software) executed on the CPU 40 of the computer system 140.

As shown in FIG. 5, when the program is executed, the main window MW is displayed on the display 144. In addition, a plurality of windows (Windows W1 to W8) is displayed within the main window MW. On the top of the main window MW, icons for menus, various operations and settings are also displayed. In this embodiment, an example is shown where eight windows are displayed, but it is also possible to display more than eight windows as necessary, or to divide, integrate or omit windows according to their purpose. The layout of each window can also be freely changed by operation of the operator.

In the first window W1, the image WG of the measurement target object W captured by the image capturing unit 120 is displayed. The operator can adjust the position of the image WG of the measurement target object W displayed in the first window W1 by operating the mouse 143 or the joystick 132 of the remote box 130, for example. In addition, the operator can also expand or shrink the image WG of the measurement target object W by selecting an icon with the mouse 143, for example.

In the second window W2, icons of the measurement tools that can be selected by the operator are displayed. The icons for the measurement tools are provided to correspond to the method of designating the measurement points from the image WG of the measurement target object W. As specific examples of measurement tools, there are straight edge detection tools, circular edge detection tools, etc.

In the third window W3, icons of functions that can be selected by the operator are displayed. The icons of functions are provided for each measurement method. For example, there are methods for measuring the coordinates of a single point, measuring the length of a straight line, measuring a circle, measuring an ellipse, measuring a square hole, measuring a long hole, measuring the pitch, and measuring the tolerance between two lines. The computer system 140 performs measurements of dimensions such as the length of a straight line, the distance between straight lines, and the diameter of a circle, and evaluations of deviations (errors) from ideal geometric shapes such as straightness, roundness, and parallelism, according to the operator's selection.

In the fourth window W4, the guidance that shows the operating procedure for measurement is displayed.

In the fifth window W5, various sliders for controlling the illumination from the image capturing unit 120 to the measurement target object W are displayed. The operator can operate this slider to irradiate the desired illumination onto the measurement target object W.

In the sixth window W6, the XY coordinate values of the stage 100 are displayed. The XY coordinate values displayed in the sixth window W6 are the X-axis coordinate and Y-axis coordinate of the stage 100 relative to a predetermined coordinate origin.

In the seventh window W7, a tolerance judgment result is displayed. Namely, when a measurement method that can perform tolerance judgment is selected, the result of the judgment is displayed in the seventh window W7.

In the eighth window W8, a measurement result is displayed. Namely, when a measurement method that obtains a measurement result by a predetermined calculation is selected, the measurement result is displayed in the eighth window W8. The details of the tolerance judgment results for the seventh window W7 and the measurement results for the eighth window W8 are omitted from the drawing.

### Binarized Image Generation and Defect Inspection

In the image measuring apparatus 1, the program (measurement application software) executed by the CPU 40 of the computer system 140 provides a function to generate a binarized image from an image of the measurement target object W, and to perform inspection of the defective parts that can be inspected based on the binarized image (hereinafter simply referred to as “defect inspection”) in addition to the basic image measurement described above. In the following description, when there is no particular reference to the subject of the processing, it should be understood that the subject is the program executed by the CPU 40 of the computer system 140.

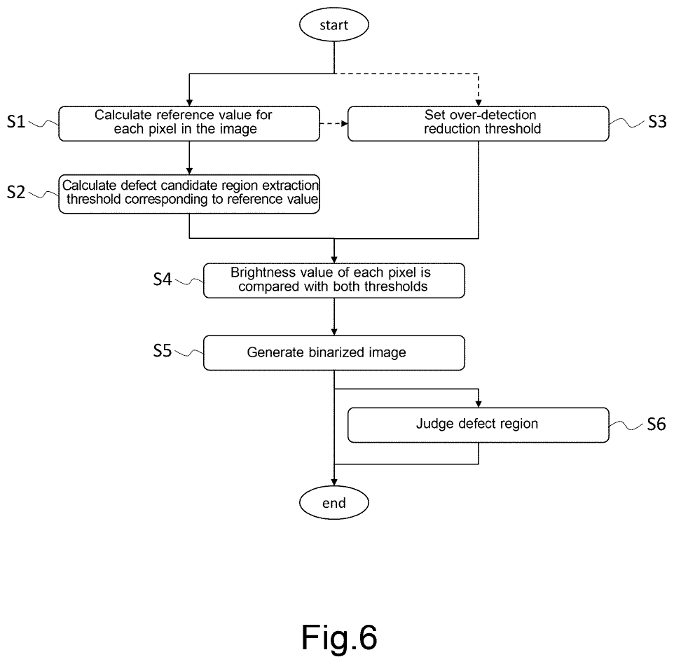

The binarized image generation method of the present invention generates a binarized image of an image of a measurement target object W. The binarized image generation method performs a reference value calculation step (S1), a defect candidate region extraction threshold calculation step (S2), an over-detection reduction threshold setting step (S3), a threshold comparison step (S4), and a binarized image generation step (S5), as shown in FIG. 6.

In addition, the defect inspection method of the present invention inspects defects in the measurement target object W using the binarized image of the measurement target object. As shown in FIG. 6, the defect inspection method performs a reference value calculation step (S1), a defect candidate region extraction threshold calculation step (S2), an over-detection reduction threshold setting step (S3), a threshold comparison step (S4), a binarized image generation step (S5), and a judgment step (S6).

In the reference value calculation step (S1), a reference value indicating the brightness of the area around the subject pixel is calculated for each pixel in the image of the measurement target object W based on the brightness values of the pixels around the subject pixel. The reference value may be, for example, the average of the brightness values of pixels in a certain range around the subject pixel.

In the defect candidate region extraction threshold calculation step (S2), a defect candidate region extraction threshold, which is a threshold of the brightness value for extracting defect candidate regions, is calculated by multiplying a certain constant based on the characteristics of the target defect by the reference value.

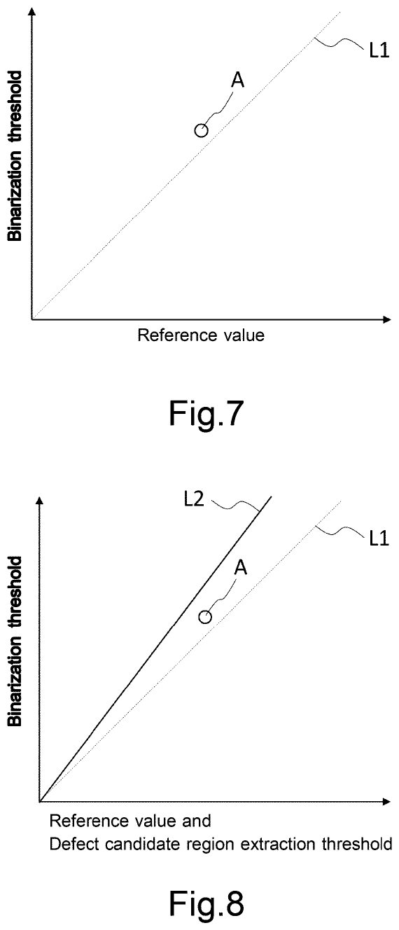

FIG. 7 shows an example of the relationship between the binarization threshold, which is the threshold for binarizing pixels, and the reference value. Here, line L1 indicates that the binarization threshold is the reference value. In other words, it indicates the case where the reference value itself is used as the binarization threshold. In this case, the image is binarized into two regions: one region consisting of pixels whose brightness values are greater than or equal to both thresholds, and the other region. Since the pixel region A shown in FIG. 7 exceeds the binarization threshold, this region is extracted as a defect candidate region. However, when the threshold is set in this way, even if the brightness must be considerably higher than the reference value according to the characteristics of the defect, regions such as pixel region A, which is only slightly higher than the reference value, will be identified as defect candidate regions, leading to a decrease in the efficiency of narrowing down the defect candidates and detection accuracy.

Therefore, in the defect candidate region extraction threshold calculation step (S2), the value obtained by multiplying a constant based on the characteristics of the defect by the reference value is calculated as the defect candidate region extraction threshold. FIG. 8 shows the line L2 added to FIG. 7 to show the defect candidate region extraction threshold that satisfies the relationship of the binarization threshold=the defect candidate region extraction threshold=the reference value×constant. In this way, by setting the binarization threshold to a value obtained by multiplying the reference value by a constant based on the characteristics of the defect, it is possible to extract pixel regions that correspond to the characteristics of the defect, and at the same time, it is possible to exclude regions such as pixel region A, which is only slightly higher than the reference value, from the defect candidates, so efficient and effective extraction of defect candidate regions is achieved.

In an over-detection reduction threshold setting step (S3), an over-detection reduction threshold for reducing the effect of noise is set.

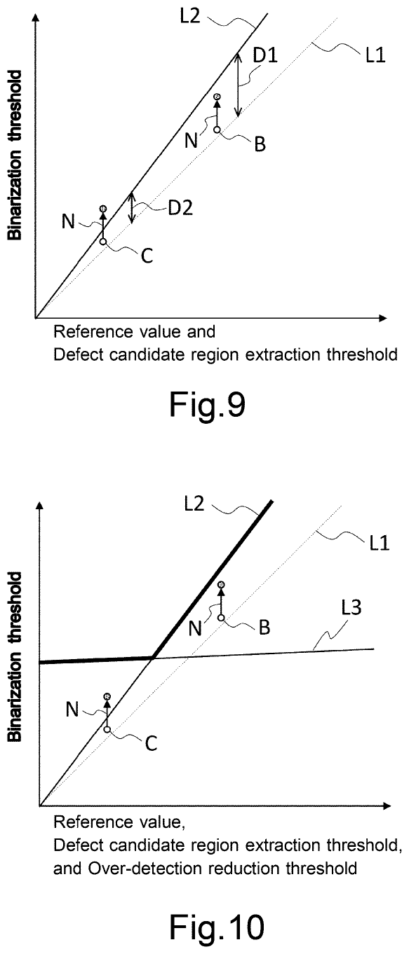

FIG. 9 shows pixel regions B and C, which originally have brightness that does not reach the defect candidate region extraction threshold, added on to FIG. 8. However, the actual image may include noise due to uneven intensity of lighting or the characteristics of the image sensor. Here, in the region of high brightness, the difference D1 between the reference value line L1 and the defect candidate region extraction threshold line L2 is large, so even if noise N is added to the brightness of pixel region B, it does not reach the defect candidate region extraction threshold. In contrast, in the region with a low reference value, the difference D2 between the values of lines L1 and L2 is small, so when noise N is added to the brightness of pixel region C, it exceeds the defect candidate region extraction threshold and is extracted as a defect candidate region, resulting in over-detection.

Therefore, in the over-detection reduction threshold setting step (S3), in order to prevent such over-detection, an over-detection reduction threshold that is greater than the defect candidate region extraction threshold in regions with low brightness is set. FIG. 10 shows line L3, which indicates the over-detection reduction threshold that satisfies the relationship between the binarization threshold for low-brightness regions=over-detection reduction threshold>defect candidate region extraction threshold, added on to FIG. 9. The over-detection reduction threshold is set based on the expected noise intensity.

For example, the optimal value (optimal line) can be identified and set by repeatedly generating binarized images while changing the over-detection reduction threshold (line L3). In this case, the over-detection reduction threshold can be set to a constant value (the slope of line L3=0), or it can be set to have a slope. When experimentally setting the over-detection reduction threshold in this way, step S3 may be performed independently of steps S1 and S2.

Alternatively, the over-detection reduction threshold may be calculated and set based on the reference value. In this case, step S3 is performed after step S1.

In the threshold comparison step (S4), the brightness value of the subject pixel is examined to see if it is above both the defect candidate region extraction threshold and the over-detection reduction threshold. In other words, the brightness value is compared using the bold line in FIG. 10 as the binarization threshold for the whole image.

In a binarized image generation step (S5), a binarized image of the measurement target which has been binarized into two regions, one consisting of pixels with brightness value above both thresholds and the other region, is generated based on the comparison result with the binarization threshold for each pixel in step S4.

In the judgment step (S6), the region consisting of pixels with brightness values above both thresholds is considered to be a defect candidate region, and the feature values of the defect candidate region are calculated. Based on these feature values, it is judged whether or not the defect candidate region is a defect region. If there are two or more defect candidate regions in the 2D image, the judgment is made for each region.

According to the binarized image generation method of the present invention explained above, in addition to using the defect candidate region extraction threshold obtained by multiplying the reference value indicating the brightness of the pixels around the subject pixel by a constant as the binarization threshold of the image, in order to reduce the over-detection of defect candidate regions due to noise, the defect candidate region is extracted using the over-detection reduction threshold as the binarization threshold in low-brightness regions. Accordingly, it is possible to generate a binarized image that suppresses the over-detection of noise when extracting defect candidate regions, and by using such a binarized image, it is also possible to suppress erroneous judgments in defect inspection based on the binarized image.

The present invention is not limited to the above embodiments. The above-mentioned embodiment is an example, and any configuration substantially the same as the technical idea described in the claims of the present invention and producing similar effects is included in the technical scope of the present invention, even if components are added, deleted, or modified. In other words, changes can be made as appropriate within the scope of the technical ideas expressed in the present invention, and forms with such changes and improvements are also included in the technical scope of the present invention. For example, in the above embodiment, the image to be binarized is the image of the measurement target object for the image measurement apparatus, but the subject of the image is arbitrary within the scope to which this invention is applicable.

With respect to the embodiments including the above examples, the following appendixes are further disclosed.

(Appendix 1) A binarized image generation method that generates a binarized image of a target object, wherein
the binarized image generation method performs for each pixel in an image of the target object:
a reference value calculation step that calculates a reference value indicating the brightness of the area around the subject pixel based on the brightness values of the pixels around the subject pixel;
a defect candidate region extraction threshold calculation step that calculates a defect candidate region extraction threshold for extracting defect candidate regions by multiplying a certain constant based on the characteristics of the target defect by the reference value;
an over-detection reduction threshold setting step that sets an over-detection reduction threshold for reducing the effect of noise; and
a threshold comparison step that determines whether the brightness value of the subject pixel is above both the defect candidate region extraction threshold and the over-detection reduction threshold, and
then performs a binarized image generation step that generates a binarized image of the target object, where the image is binarized into two regions: one region consisting of pixels whose brightness values are greater than or equal to both thresholds, and the other region.

(Appendix 2) The binarized image generation method as described in appendix 1, wherein the target object is a measurement target object of an image measuring apparatus.

(Appendix 3) The binarized image generation method as described in appendix 1, wherein the reference value is the average of the brightness values of the pixels around the subject pixel.

(Appendix 4) The binarized image generation method as described in appendix 1, wherein the over-detection reduction threshold is a constant value.

(Appendix 5) A defect inspection method performing:
the binarized image generation method as described in any one of appendixes 1 to 4; and
a judgment step that calculates feature values of a defect candidate region, and judges whether or not the defect candidate region is a defect region based on the feature value, where the region consisting of pixels with brightness values above both thresholds is considered to be the defect candidate region.

(Appendix 6) A program for causing a computer to execute the binarized image generation method as described in any one of appendixes 1 to 4, and a non-transitory recording medium on which said program is recorded.

(Appendix 7) A program for causing a computer to perform the defect inspection method according to appendix 5 and a non-transitory recording medium on which said program is recorded.

What is claimed is:

1. A binarized image generation method that generates a binarized image of a target object, wherein the binarized image generation method performs for each pixel in an image of the target object:
a reference value calculation step that calculates a reference value indicating the brightness of the area around the subject pixel based on the brightness values of the pixels around the subject pixel;
a defect candidate region extraction threshold calculation step that calculates a defect candidate region extraction threshold for extracting defect candidate regions by multiplying a certain constant based on the characteristics of the target defect by the reference value;
an over-detection reduction threshold setting step that sets an over-detection reduction threshold for reducing the effect of noise; and
a threshold comparison step that determines whether the brightness value of the subject pixel is above both the defect candidate region extraction threshold and the over-detection reduction threshold, and
then performs a binarized image generation step that generates a binarized image of the target object, where the image is binarized into two regions: one region consisting of pixels whose brightness values are greater than or equal to both thresholds, and the other region.

2. The binarized image generation method as claimed in claim 1, wherein the target object is a measurement target object of an image measuring apparatus.

3. The binarized image generation method as claimed in claim 1, wherein the reference value is the average of the brightness values of the pixels around the subject pixel.

4. The binarized image generation method as claimed in claim 1, wherein the over-detection reduction threshold is a constant value.

5. A defect inspection method performing:
the binarized image generation method as claimed in claim 1; and
a judgment step that calculates feature values of a defect candidate region, and judges whether or not the defect candidate region is a defect region based on the feature value, where the region consisting of pixels with brightness values above both thresholds is considered to be the defect candidate region.

6. A non-transitory recording medium recording a program for causing a computer to perform the binarized image generation method according to claim 1.

7. A non-transitory recording medium recording a program for causing a computer to perform the defect inspection method according to claim 5.
